(19) United States
(12) Patent Application Publication
(10) Pub. No.: US 2025/0066591 A1
(43) Pub. Date: Feb. 27, 2025

(54) RUBBER FORMULATIONS COMPRISING FUNCTIONALIZED CONJUGATED DIENE POLYMER, NATURAL RUBBER, AND REINFORCING FILLER

(71) Applicants: BRIDGESTONE CORPORATION, Chuo-ku, Tokyo (JP); Bridgestone Americas Tire Operations, LLC, Nashville, TN (US)

(72) Inventors: Vrushali BHAGAT, Ann Arbor, MI (US); Walter Anthony SALAMANT, Akron, OH (US); Xiaoyu WEI, Akron, OH (US); Jamie Lynn WHYTE, Akron, OH (US); Seth Martin MILLER, Akron, OH (US); Shammi AHMED, Akron, OH (US)

(21) Appl. No.: 18/724,459

(22) PCT Filed: Dec. 29, 2022
(86) PCT No.: PCT/US2022/082540

§ 371 Date: Jun. 26, 2024

Related U.S. Application Data
(60) Provisional application No. 63/294,547, filed on Dec. 29, 2021.
(60) Provisional application No. 63/294,551, filed on Dec. 29, 2021.

(51) Int. Cl. C08L 15/00; C08L 7/00

(52) U.S. Cl. CPC C08L 15/00; C08L 7/00

(57) ABSTRACT

Embodiments of the present disclosure are directed to rubber formulations, wherein the rubber formulations comprise functionalized conjugated diene polymer, natural rubber, and reinforcing filler comprising at least one of silica and carbon black. The functionalized conjugated diene polymer has a functional group, a vinyl content greater than or equal to 50%, and a weight average molecular weight M_{w} of about 75,000 g/mol to about 1,000,000 g/mol.

### TECHNICAL FIELD

Embodiments of the present disclosure are generally related to functionalized conjugated diene polymers, and are specifically related to rubber formulations including functionalized conjugated diene polymer, natural rubber, and reinforcing filler, which have improved filler dispersion.

### BACKGROUND

Rubber formulations comprising natural rubber, butadiene rubber, and reinforcing filler, such as silica and carbon black, are commonly used in tire applications, for example, tire tread. However, sufficient dispersion of silica and/or carbon black in natural rubber may be difficult due to poor interaction of natural rubber with silica and/or carbon black, leading to increased rolling resistance.

Accordingly, a continual need exists for improved rubber formulations that have improved filler dispersion, thereby providing reduced rolling resistance.

### SUMMARY

Embodiments of the present disclosure are directed to rubber formulations of functionalized conjugated diene polymer and natural rubber, which have improved rolling resistance due to improved filler dispersion. Specifically, high-cis 1,4-polybutadiene rubber has low miscibility with natural rubber. The rubber formulations disclosed herein replace natural rubber with functionalized conjugated diene polymer, which is preferentially miscible with natural rubber and favors the natural rubber phase over another diene polymer phase that is not miscible with natural rubber, such as a high-cis 1,4-polybutadiene rubber phase. The functional groups of the functionalized conjugated diene polymer may react with silica or carbon black and improve silica or carbon black dispersion in the natural rubber phase.

According to one embodiment, a rubber formulation is provided. The rubber formulation comprises functionalized conjugated diene polymer, natural rubber, and reinforcing filler comprising at least one of silica and carbon black. The functionalized conjugated diene polymer has a functional group, a vinyl content greater than or equal to about 50%, and a weight average molecular weight M_{w} of about 75,000 g/mol to about 1,000,000 g/mol.

Additional features and advantages of the embodiments described herein will be set forth in the detailed description which follows, and in part will be readily apparent to those skilled in the art from that description or recognized by practicing the embodiments described herein, including the detailed description which follows, and the claims.

### DETAILED DESCRIPTION

Embodiments of the present disclosure are directed to rubber formulations. The rubber formulations comprise functionalized conjugated diene polymer, natural rubber, and reinforcing filler comprising at least one of silica and carbon black. The functionalized conjugated diene polymer has a functional group, a vinyl content greater than or equal to about 50%, and a weight average molecular weight M_{w} of about 75,000 g/mol to about 1,000,000 g/mol. The disclosure should not be construed as limited to the embodiments set forth herein. Rather, these embodiments are provided so that this disclosure will be thorough and complete, and will fully convey the subject matter to those skilled in the art.

### Definitions

Unless otherwise defined, all technical and scientific terms used herein have the same meaning as commonly understood by one of ordinary skill in the art. The terminology used in the disclosure herein is for describing particular embodiments only and is not intended to be limiting.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used in the specification and the appended claims, the singular forms “a,” “an,” and “the” are intended to include the plural forms as well, unless the context clearly indicates otherwise. Thus, for example, reference to “a” component includes aspects having two or more such components, unless the context clearly indicates otherwise.

The term “phr,” as described herein, refers to parts by weight of the identified component per 100 parts rubber.

The term “rubber formulation,” as described herein, refers to the rubber (i.e., functionalized conjugated diene polymer, natural rubber, and optionally high-cis 1,4-polybutadiene rubber) and the additional fillers and additives blended therewith in tire and non-tire applications.

The term “vinyl content,” as described herein, refers to the percentage of vinyl 1,2 linkages in a polydiene, such as the functionalized conjugated diene polymer. The “vinyl content” is determined by 400 MHz Nuclear Magnetic Resonance using CDCl₃ as the solvent.

The term “high-vinyl,” as used herein, means a vinyl 1,2 linkage content greater than or equal to 50% in the functionalized conjugated diene polymer.

The term “cis content,” as described herein, refers to the percentage of cis 1,4 linkages in the polydiene.

The term “high-cis,” as used herein, means a cis-1,4-linkage content of 85% or greater in the resulting polydiene.

The term “non-sulfur,” as used herein, refers to a moiety without any sulfur atoms.

The term “control rubber formulation,” as used herein refers to a rubber formulation that includes natural rubber, high-cis 1,4-polybutadiene rubber, and silica and/or carbon black and does not include a synthetic conjugated diene polymer miscible with natural rubber.

Number average molecular weight Mₙ, weight average molecular weight M_{w}, and peak molecular weight Mₚ, as described herein, are determined by gel permeation chromatography.

Glass transition temperature T_{g}, as described herein, is measured by differential scanning calorimetry.

The Mooney viscosity, as described herein, is determined using a Monsanto Mooney viscometer.

The tensile mechanical properties modulus at 100% strain M100, modulus at 300% strain M300, stress at break (Tb), and maximum strain (Eb), described herein, are determined in accordance with ASTM D412.

The viscoelastic properties loss tangent tan δ (2%), loss tangent tan δ (5%), loss tangent tan δ (10%), and change in storage modulus ΔG′ (0.25-10%), described herein were measured by a strain sweep test conducted with an Advanced Rheometric Expansion System from TA Instruments.

The viscoelastic property loss modulus G″, as described herein, was measured by a temperature sweep test conducted with an Advanced Rheometric Expansion System from TA Instruments.

The viscoelastic properties loss tangent tan δ (0° C.), loss tangent tan δ (60° C.), and storage modulus E′ at 30° C., described herein, were measured by a temperature sweep test conducted with a GABO Eplexor at 2% strain with varied temperature.

As discussed hereinabove, natural and butadiene rubber blends including silica and/or carbon black are commonly used in tire tread applications. However, natural rubber may react poorly with silica and/or carbon black, leading to poor silica and/or carbon black dispersion in the natural rubber and increased rolling resistance.

Disclosed herein are rubber formulations which mitigate the aforementioned problems. Specifically, high-cis 1,4-polybutadiene rubber has low miscibility with natural rubber. The rubber formulations disclosed herein replace natural rubber with functionalized conjugated diene polymer, which is preferentially miscible with natural rubber and favors the natural rubber phase over another diene polymer phase that is not miscible with natural rubber, such as a high-cis 1,4-polybutadiene rubber phase. The functional groups of the functionalized conjugated diene polymer may react with silica or carbon black and improve silica or carbon black dispersion in the natural rubber phase. The improved filler dispersion through polymer-filler interaction manifests in improved rheological properties, such as reduced change in storage modulus ΔG′, which correlates to improved filler dispersion, and a decrease in loss tangent tan δ at 60° C., which correlates to reduced rolling resistance, as compared to a control rubber formulation having natural rubber and high-cis 1,4-polybutadiene rubber. Moreover, replacing natural rubber with functionalized conjugated diene polymer has minimal to no effect on tensile properties (e.g., modulus at 300% strain M300, stress at break Tb, and maximum strain Eb), wet traction (as indicated by loss tangent tan δ at 0° C., and cornering coefficient as indicated by storage modulus E′ at 30° C.).

The rubber formulations disclosed herein may generally be described as comprising functionalized conjugated diene polymer, natural rubber, and reinforcing filler comprising silica and/or carbon black.

As used herein, the term “natural rubber” means naturally occurring rubber such as can be harvested from sources such as Hevea rubber trees and non-Hevea sources (e.g., guayule shrubs and dandelions such as TKS). In other words, the term “natural rubber” should be construed so as to exclude synthetic polyisoprene.

As used herein the term “polyisoprene” means synthetic polyisoprene. In other words, the term is used to indicate a polymer that is manufactured from isoprene monomers, and should not be construed as including naturally occurring rubber (e.g., Hevea natural rubber, guayule-sourced natural rubber, or dandelion-sourced natural rubber). However, the term polyisoprene should be construed as including polyisoprenes manufactured from natural sources of isoprene monomer.

### Functionalized Conjugated Diene Polymer

As described hereinabove, replacing natural rubber with functionalized conjugated diene polymer improves silica or carbon black dispersion in the natural rubber, leading to reduced rolling resistance.

The functionalized conjugated diene polymer described may have a functional group that reacts with silica to improve silica dispersion in the natural rubber phase. For example, in embodiments, the functional group of the functionalized conjugated diene polymer comprises a non-sulfur alkoxysilane group. In embodiments, the non-sulfur alkoxysilane group may have at least one alkoxysilane terminal moieties, and in further embodiments, two or three alkoxysilane terminal moieties. The alkoxysilane terminal moieties may comprise C₁-C₆ alkoxy groups, and in specific embodiments may comprise methoxysilane or ethoxysilane.

More generally, in embodiments, the functional group may be represented by general formula (I):

$${R}^{1} {ZY Si ( {O R}^{2} )}_{n} {X}_{( 3 - n )} \qquad ( I )$$

In the formula R¹ is a substituent selected from a C₁-C₂₀ aliphatic hydrocarbon group, a C₁-C₂₀ alicyclic hydrocarbon group, C₁-C₂₀ aromatic hydrocarbon group, and a C₁-C₂₀ heterohydrocarbon group having one or more heteroatoms selected from O, N, and Si. In one or more embodiments, the C₁-C₂₀ heterohydrocarbon group may comprise an unsaturated carbonyl, an alkylsilyl group (e.g., trimethylsilyl), an epoxy group, or a glycidoxy group.

X denotes an alkyl group (1 to 20 carbon atoms) or halogen atom, and R² and Y independently denote a group selected from aliphatic, alicyclic and aromatic hydrocarbon groups of 1 to 20 carbon atoms or even 1 to 13 carbon atoms. An alkyl group of 1 to 3 carbon atoms may be desirable in view of reactivity with silica. The aromatic hydrocarbon group may be, for example, phenyl, naphthyl, biphenyl, anthryl, or phenanthryl.

Additionally, Z is a O atom, an N atom, or a bond, and n denotes an integer from 1 to 3.

In further embodiments, the R¹ may denote a group selected from the group consisting of γ-glycidoxyethyl, γ-glycidoxypropyl, γ-glycidoxybutyl, γ-methacryloxymethyl, γ-methacryloxyethyl, γ-methacryloxypropyl, β-(3,4-epoxycyclohexyl)ethyl, and β-(3,4-epoxycyclohexyl)propyl.

The functional group represented by the general formula (I) may include, for example, γ-glycidoxyethyl trimethoxysilane, γ-glycidoxypropyl trimethoxysilane, γ-glycidoxybutyl trimethoxysilane, γ-glycidoxypropyl triethoxysilane, γ-glycidoxypropyl tripropoxysilane, γ-glycidoxypropyl tributoxysilane, γ-glycidoxypropyl triphenoxysilane, γ-glycidoxypropyl methyldimethoxysilane, γ-glycidoxypropyl ethyldimethoxysilane, γ-glycidoxypropyl ethyldiethoxysilane, γ-glycidoxypropyl methyldiethoxysilane, γ-glycidoxypropyl methyldipropoxysilane, γ-glycidoxypropyl methyldibutoxysilane, γ-glycidoxypropyl methyldiphenoxysilane, γ-glycidoxypropyl dimethylmethoxysilane, γ-glycidoxypropyl diethylethoxysilane, γ-glycidoxypropyl dimethylethoxysilane, γ-glycidoxypropyl dimethylphenoxysilane, γ-glycidoxypropyl diethylmethoxysilane, γ-glycidoxypropyl methyldiisopropenoxysilane, bis(γ-glycidoxypropyl)dimethoxysilane, bis(γ-glycidoxypropyl)diethoxysilane, bis(γ-glycidoxypropyl)dipropoxysilane, bis(γ-glycidoxypropyl)dibutoxysilane, bis(γ-glycidoxypropyl)diphenoxysilane, bis(γ-glycidoxypropyl)methylmethoxysilane, bis(γ-glycidoxypropyl)methylethoxysilane, bis(γ-glycidoxypropyl)methylpropoxysilane, bis(γ-glycidoxypropyl)methylbutoxysilane, bis(γ-glycidoxypropyl)methylphenoxysilane, tris(γ-glycidoxypropyl)methoxysilane, γ-methacryloxypropyl trimethoxysilane, γ-methacryloxypropyl triethoxysilane, γ-methacryloxymethyl trimethoxysilane, γ-methacryloxyethyl triethoxysilane, bis(γ-methacryloxypropyl)dimethoxysilane, tris(γ-methacryloxypropyl)methoxysilane, β-(3,4-epoxycyclohexyl)ethyl-trimethoxysilane, β-(3,4-epoxycyclohexyl)ethyl-triethoxysilane, β-(3,4-epoxycyclohexyl)ethyl-tripropoxysilane, β-(3,4-epoxycyclohexyl)ethyl-tributoxysilane, β-(3,4-epoxycyclohexyl)ethyl-triphenoxysilane, β-(3,4-epoxycyclohexyl)propyl-trimethoxysilane, β-(3,4-epoxycyclohexyl)ethyl-methyldimethoxysilane, β-(3,4-epoxycyclohexyl)ethyl-ethyldimethoxysilane, β-(3,4-epoxycyclohexyl)ethyl-ethyldiethoxysilane, β-(3,4-epoxycycloexyl)ethyl-methyldiethoxysilane, β-(3,4-epoxycyclohexy)ethyl-methyldipropoxysilane, β-(3,4-epoxycyclohexyl)ethyl-methyldibutoxysilane, β-(3,4-epoxycyclohexyl)ethyl-methyldiphenoxysilane, β-(3,4-epoxycyclohexyl)ethyl-dimethylmethoxysilane, β-(3,4-epoxycyclohexyl)ethyl-diethylethoxysilane, β-(3,4-epoxycyclohexyl)ethyl-dimethylethoxysilane, β-(3,4-epoxycyclohexyl)ethyl-dimethylpropoxysilane, β-(3,4-epoxycyclohexyl)ethyl-dimethylbutoxysilane, β-(3,4-epoxycyclohexyl)ethyl-dimethylphenoxysilane, β-(3,4-epoxycyclohexyl)ethyl-diethylmethoxysilane, β-(3,4-epoxycyclohexyl)ethyl-methyldiisopropenoxysilane, and the like.

In embodiments, the non-sulfur alkoxysilane group may be an aminoalkylalkoxysilane, such as 3-(1,3-dimethylbutylidene)aminopropylmethyldiethoxysilane, 3-(1,3-dimethylbutylidene)aminopropylmethyldimethoxysilane, 3-(1,3-dimethylbutylidene)aminopropyltriethoxysilane, 3-(1,3-dimethylbutylidene)aminopropyltrimethoxysilane, 3-(1,3-dimethylbutylidene)aminoethylmethyldiethoxysilane, 3-(1,3-dimethylbutylidene)aminoethylmethyldimethoxysilane, 3-(1,3-dimethylbutylidene)aminoethyltriethoxysilane, 3-(1,3-dimethylbutylidene)aminoethyltrimethoxysilane, 3-(1,3-dimethylbutylidene)aminobutylmethyldiethoxysilane, 3-(1,3-dimethylbutylidene)aminobutylmethyldimethoxysilane, 3-(1,3-dimethylbutylidene)aminobutyltriethoxysilane, 3-(1,3-dimethylbutylidene)aminobutyltrimethoxysilane, N,N-bis(trimethylsilyl)-aminopropylmethyldiethoxysilane, N,N-bis(trimethylsilyl)-aminopropylmethyldimethoxysilane, N,N-bis(trimethylsilyl)-aminopropyltriethoxysilane, N,N-bis(trimethylsilyl)-aminopropyltrimethoxysilane, N,N-bis(trimethylsilyl)-aminoethylmethyldiethoxysilane, N,N-bis(trimethylsilyl)-aminoethylmethyldimethoxysilane, N,N-bis(trimethylsilyl)-aminoethyltriethoxysilane, N,N-bis(trimethylsilyl)-aminoethyltrimethoxysilane, N,N-bis(trimethylsilyl)-aminobutylmethyldiethoxysilane, N,N-bis(trimethylsilyl)-aminobutylmethyldimethoxysilane, N,N-bis(trimethylsilyl)-aminobutyltriethoxysilane, or N,N-bis(trimethylsilyl)-aminobutyltrimethoxysilane.

In some embodiments, the functionalized conjugated diene polymer described herein may have a functional group that reacts with carbon black to improve carbon black dispersion in the natural rubber phase. For example, in embodiments, the functional group of the functionalized conjugated diene polymer comprises a tin-based group, an amine group, or a combination thereof. The functionalization may be installed as either an initiator for the polymerization or as a reactive terminator.

In embodiments, the tin-based group may comprise tin halide (e.g., chloride, bromide, iodide, and fluoride). For example, in embodiments, the tin halide may comprise tetra halide, (R₁)₃SnX, (R₁)₂SnX₂, R₁SnX₃, or a combination thereof, where X is Cl, Br, I, or F, and R₁ is an alkyl, cycloalkyl, or aralkyl having from 1 to about 20 carbon atoms. By way of example, and not limitation, the tin halide may comprise tin tetra chloride, (R₁)₃SnCl, (R₁)₂SnCl₂, R₁SnCl₃, or a combination thereof, where R₁ is an alkyl, cycloalkyl, or aralkyl having from 1 to about 20 carbon atoms.

In embodiments, the amine group may be a dialkyl or dicycloalkyl amine radical having the general formula:

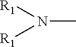

or a cyclic amine radical having the general formula:

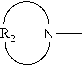

In these formulas, R₁ is an alkyl, cycloalkyl, or aralkyl having from 1 to about 20 carbon atoms, where both R₁ groups may be the same or different, and R₂ is an alkylene substituted, oxy- or N-alkylamino-alkylene group having from about 3 to about 16 methylene groups. The amino-alkylene group may be an N-alkylamino alkylene. By “substituted alkylene,” it is understood that the alkylene has a substituent thereon. Substituted alkylenes may include mono- to octa-substituted alkylenes. In embodiments, the substituents may be linear or branched alkyls, cycloalkyls, bicycloalkyls, aryls, and aralkyls having from 1 to about 12 carbon atoms.

Exemplary R₁ groups may include methyl, ethyl, butyl, octyl, cyclohexyl, 3-phenyl-1-propyl, isobutyl, and the like. Exemplary R₂ groups may include tetramethylene, hexamethylene, oxydiethylene, N-alkylazadiethylene, dodecamethylene, hexadecamethylene, and the like.

For example, the amine group may be a derivative or radical of pyrrolidine; piperidine; monoalkyl-piperazine; perhydroazepine such as 3,3,5-trimethylhexahydroazepine and hexamethyleneimine; 1-azacyclooctane; azacyclotridecane, also known as dodecamethyleneimine; azacycloheptadecane, also known as hexadecamethyleneimine; 1-azacycloheptadec-9-ene; or, 1-azacycloheptadec-8-ene; including bicyclics such as perhydroisoquinoline, perhydroindole, 1,3,3-trimethyl-6-azabicyclo [3.2.1]octane, and the like.

There are many useful examples of the alkyl, cycloalkyl, aryl and aralkyl substituents of the cyclic and bicyclic amines of the invention, including, but not limited to 2-(2-ethylhexyl)pyrrolidine; 3-(2-propyl)pyrrolidine; 3,5-bis(2-ethylhexyl) piperidine; 4-phenylpiperidine; 7-decyl-1-azacyclotridecane; 3,3-dimethyl-1-azacyclotetradecane; 4-dodecyl-1-azacyclooctane; 4-(2-phenylbutyl)-1-azacyclooctane; 3-ethyl-5-cyclohexyl-1-azacycloheptane; 4-hexyl-1-azacycloheptane; 9-isoamyl-1-azacycloheptadecane; 2-methyl-1-azacycloheptadec-9-ene; 3-isobutyl-1-azacyclododecane; 2-methyl-7-t-butyl-1-azacyclododecane; 5-nonyl-1-azacyclodecane; 8-(4′-methylphenyl)-5-pentyl-3-azabicyclo[5.4.0]undecane; 1-butyl-6-azabicyclo[3.2.1]octane; 8-ethyl-3-azabicyclo[3.2.1.]octane; 1-propyl-3-azabicyclo[3.2.2]nonane; 3-t-butyl)-7-azabicyclo[4.3.0]nonane; 1,5,5-trimethyl-3-azabicyclo[4.4.0]decane; and the like.

When R₁ and R₂ are each branched in the alkyl position, such as di-t-butyl, diisopropyl, tertiary butyl or the like, the resulting polymerizations are slow, presumably due to hindrance around the nitrogen at the initiation site. Hence, in embodiments, the carbon atoms in R₁ and R₂ which are bonded to the nitrogen in the amine, may also be bonded to a total of at least three hydrogen atoms.

In embodiments, the functionalized conjugated diene polymer may have a vinyl content greater than or equal to about 50%. In embodiments, the functionalized conjugated diene may have a vinyl content greater than or equal to about 50%, greater than or equal to about 55%, greater than or equal to about 60%, greater than or equal to about 63%, greater than or equal to about 65%, or even greater than or equal to about 67%. In embodiments, the functionalized conjugated diene may have a vinyl content less than or equal to about 90%, less than or equal to about 85%, less than or equal to about 80%, less than or equal to about 77%, less than or equal to about 75%, or even less than or equal to about 73%. In embodiments, the functionalized conjugated diene polymer may have a vinyl content from about 50% to about 90%, from about 50% to about 85%, from about 50% to about 80%, from about 50% to about 77%, from about 50% to about 75%, from about 50% to about 73%, about 55% to about 90%, from about 55% to about 85%, from about 55% to about 80%, from about 55% to about 77%, from about 55% to about 75%, from about 55% to about 73%, about 60% to about 90%, from about 60% to about 85%, from about 60% to about 80%, from about 60% to about 77%, from about 60% to about 75%, from about 60% to about 73%, about 63% to about 90%, from about 63% to about 85%, from about 63% to about 80%, from about 63% to about 77%, from about 63% to about 75%, from about 63% to about 73%, about 65% to about 90%, from about 65% to about 85%, from about 65% to about 80%, from about 65% to about 77%, from about 65% to about 75%, from about 65% to about 73%, about 67% to about 90%, from about 67% to about 85%, from about 67% to about 80%, from about 67% to about 77%, from about 67% to about 75%, or even from about 67% to about 73%, or any and all sub-ranges formed from any of these endpoints.

In embodiments, the functionalized conjugated diene polymer may have a weight average molecular weight M_{w} of about 75,000 g/mol to about 1,000,000 g/mol. In embodiments, the functionalized conjugated diene may have a weight average molecular weight M_{w} greater than or equal to 75,000 g/mol, greater than or equal to 100,000 g/mol, greater than or equal to 200,000 g/mol, or even greater than or equal to 300,000 g/mol. In embodiments, the functionalized conjugated diene may have a weight average molecular weight M_{w} less than or equal to 1,000,000 g/mol, less than or equal to 800,000 g/mol, less than or equal to 600,000 g/mol, or even less than or equal to 400,000 g/mol. In embodiments, the functionalized conjugated diene polymer may have a molecular weight M_{w} from about 75,000 g/mol to about 1,000,000 g/mol, from about 75,000 g/mol to about 800,000 g/mol, from about 75,000 g/mol to about 600,000 g/mol, from about 75,000 g/mol to about 400,000 g/mol, from about 100,000 g/mol to about 1,000,000 g/mol, from about 100,000 g/mol to about 800,000 g/mol, from about 100,000 g/mol to about 600,000 g/mol, from about 100,000 g/mol to about 400,000 g/mol, from about 200,000 g/mol to about 1,000,000 g/mol, from about 200,000 g/mol to about 800,000 g/mol, from about 200,000 g/mol to about 600,000 g/mol, from about 200,000 g/mol to about 400,000 g/mol, from about 300,000 g/mol to about 1,000,000 g/mol, from about 300,000 g/mol to about 800,000 g/mol, from about 300,000 g/mol to about 600,000 g/mol, or even from about 300,000 g/mol to about 400,000 g/mol, or any and all sub-ranges formed from any of these endpoints.

In embodiments, the functionalized conjugated diene polymer may have a number average molecular weight Mₙ of about 75,000 g/mol to about 1,000,000 g/mol. In embodiments, the functionalized conjugated diene may have a number average molecular weight Mₙ greater than or equal to 75,000 g/mol, greater than or equal to 100,000 g/mol, greater than or equal to 200,000 g/mol, or even greater than or equal to 300,000 g/mol. In embodiments, the functionalized conjugated diene may have a number average molecular weight Mₙ less than or equal to 1,000,000 g/mol, less than or equal to 800,000 g/mol, less than or equal to 600,000 g/mol, or even less than or equal to 400,000 g/mol. In embodiments, the functionalized conjugated diene polymer may have a molecular weight Mₙ from about 75,000 g/mol to about 1,000,000 g/mol, from about 75,000 g/mol to about 800,000 g/mol, from about 75,000 g/mol to about 600,000 g/mol, from about 75,000 g/mol to about 400,000 g/mol, from about 100,000 g/mol to about 1,000,000 g/mol, from about 100,000 g/mol to about 800,000 g/mol, from about 100,000 g/mol to about 600,000 g/mol, from about 100,000 g/mol to about 400,000 g/mol, from about 200,000 g/mol to about 1,000,000 g/mol, from about 200,000 g/mol to about 800,000 g/mol, from about 200,000 g/mol to about 600,000 g/mol, from about 200,000 g/mol to about 400,000 g/mol, from about 300,000 g/mol to about 1,000,000 g/mol, from about 300,000 g/mol to about 800,000 g/mol, from about 300,000 g/mol to about 600,000 g/mol, or even from about 300,000 g/mol to about 400,000 g/mol, or any and all sub-ranges formed from any of these endpoints.

In embodiments, the functionalized conjugated diene polymer may have a peak molecular weight Mₚ of about 75,000 g/mol to about 1,000,000 g/mol. In embodiments, the functionalized conjugated diene may have a peak molecular weight Mₚ greater than or equal to 75,000 g/mol, greater than or equal to 100,000 g/mol, greater than or equal to 200,000 g/mol, or even greater than or equal to 300,000 g/mol. In embodiments, the functionalized conjugated diene may have a molecular weight M_{w} less than or equal to 1,000,000 g/mol, less than or equal to 800,000 g/mol, less than or equal to 600,000 g/mol, or even less than or equal to 400,000 g/mol. In embodiments, the functionalized conjugated diene polymer may have a peak molecular weight Mₚ from about 75,000 g/mol to about 1,000,000 g/mol, from about 75,000 g/mol to about 800,000 g/mol, from about 75,000 g/mol to about 600,000 g/mol, from about 75,000 g/mol to about 400,000 g/mol, from about 100,000 g/mol to about 1,000,000 g/mol, from about 100,000 g/mol to about 800,000 g/mol, from about 100,000 g/mol to about 600,000 g/mol, from about 100,000 g/mol to about 400,000 g/mol, from about 200,000 g/mol to about 1,000,000 g/mol, from about 200,000 g/mol to about 800,000 g/mol, from about 200,000 g/mol to about 600,000 g/mol, from about 200,000 g/mol to about 400,000 g/mol, from about 300,000 g/mol to about 1,000,000 g/mol, from about 300,000 g/mol to about 800,000 g/mol, from about 300,000 g/mol to about 600,000 g/mol, or even from about 300,000 g/mol to about 400,000 g/mol, or any and all sub-ranges formed from any of these endpoints.

In embodiments, the functionalized conjugated diene polymer may comprise a polymerized reaction product of 1,3 butadiene monomer. In embodiments, the functionalized conjugated diene polymer may comprise polybutadiene. In embodiments, the functionalized conjugated diene polymer may comprise high-vinyl polybutadiene rubber.

In embodiments, the amount of functionalized conjugated diene polymer in the rubber formulation may be greater than about 3 phr, greater than or equal to about 6 phr, greater than or equal to about 9 phr, or even greater than or equal to about 12 phr. In embodiments, the amount of functionalized conjugated diene polymer in the rubber formulation may be less than or equal to about 30 phr, less than or equal to about 25 phr, less than or equal to about 20 phr, or even less than or equal to about 15 phr. In embodiments, the amount of functionalized conjugated diene polymer in the rubber formulation may be from about 3 phr to about 30 phr, from about 3 phr to about 25 phr, from about 3 phr to about 20 phr, from about 3 phr to about 15 phr, from about 6 phr to about 30 phr, from about 6 phr to about 25 phr, from about 6 phr to about 20 phr, from about 6 phr to about 15 phr, from about 9 phr to about 30 phr, from about 9 phr to about 25 phr, from about 9 phr to about 20 phr, from about 9 phr to about 15 phr, from about 12 phr to about 30 phr, from about 12 phr to about 25 phr, from about 12 phr to about 20 phr, or even from about 12 phr to about 15 phr, or any and all sub-ranges formed from any of these endpoints.

In embodiments, the amount of functionalized conjugated diene polymer in the rubber formulation may be greater than or equal to about 3 phr, greater than or equal to about 5 phr, greater than or equal to about 10 phr, greater than or equal to about 15 phr, or even greater than or equal to about 20 phr. In embodiments, the amount of functionalized conjugated diene polymer in the rubber formulation may be less than or equal to about 50 phr, less than or equal to about 40 phr, less than or equal to about 30 phr, or even less than or equal to about 20 phr. In embodiments, the amount of functionalized conjugated diene polymer in the rubber formulation may be from about 3 phr to about 50 phr, from about 3 phr to about 40 phr, from about 3 phr to about 30 phr, from about 3 phr to about 20 phr, from about 5 phr to about 50 phr, from about 5 phr to about 40 phr, from about 5 phr to about 30 phr, from about 5 phr to about 20 phr, from about 10 phr to about 50 phr, from about 10 phr to about 40 phr, from about 10 phr to about 30 phr, from about 10 phr to about 20 phr, from about 15 phr to about 50 phr, from about 15 phr to about 40 phr, from about 15 phr to about 30 phr, from about 15 phr to about 20 phr, from about 20 phr to about 50 phr, from about 20 phr to about 40 phr, or even from about 20 phr to about 30 phr, or any and all sub-ranges formed from any of these endpoints.

### Natural Rubber

As described hereinabove, replacing natural rubber with functionalized conjugated diene polymer improves silica or carbon black dispersion in the natural rubber, leading to reduced rolling resistance.

In embodiments, the amount of natural rubber in the rubber formulation may be greater than or equal to about 10 phr, greater than or equal to about 20 phr, greater than or equal to about 30 phr, greater than or equal to about 40 phr, or even greater than or equal to about 50 phr. In embodiments, the amount of natural rubber in the rubber formulation may be less than or equal to about 100 phr, less than or equal to about 90 phr, or even less than or equal to about 80 phr. In embodiments, the amount of natural rubber in the rubber formulation may be from about 10 phr to about 100 phr, from about 10 phr to about 90 phr, from about 10 phr to about 80 phr, from about 20 phr to about 100 phr, from about 20 phr to about 90 phr, from about 20 phr to about 80 phr, from about 30 phr to about 100 phr, from about 30 phr to about 90 phr, from about 30 phr to about 80 phr, from about 40 phr to about 100 phr, from about 40 phr to about 90 phr, from about 40 phr to about 80 phr, from about 50 phr to about 100 phr, from about 50 phr to about 90 phr, or even from about 10 phr to about 50 phr, or any and all sub-ranges formed from any of these endpoints.

In embodiments, the amount of natural rubber in the rubber formulation may be greater than about 0 phr, greater than or equal to about 15 phr, or even greater than or equal to about 30 ph. In embodiments, the amount of natural rubber in the rubber formulation may be less than or equal to 85 phr, less than or equal to about 75 phr, or even less than or equal to about 60 phr. In embodiments, the amount of natural rubber in the rubber formulation may be from greater than about 0 phr to 85 phr, from greater than about 0 phr to about 75 phr, from greater than about 0 phr to about 60 phr, from about 15 phr to about 85 phr, from about 15 phr to about 75 phr, from about 15 phr to about 60 phr, from about 30 phr to about 85 phr, from about 30 phr to about 75 phr, or even from about 30 phr to about 60 phr, or any and all sub-ranges formed from any of these endpoints.

In embodiments, in addition to natural rubber, the rubber formulation may comprise high-cis 1,4-polybutadiene rubber. In embodiments, the amount of high-cis 1,4-polybutadiene rubber in the rubber formulation may be from about 15 phr to about 45 phr, from about 15 phr, to about 35 phr, from about 25 phr to about 45 phr, or even from about 25 phr to about 30 phr, or any and all sub-ranges formed from any of these endpoints.

### Reinforcing Filler

When dispersed within the natural rubber in the rubber formulations described herein, silica and/or carbon black provides a reinforcing effect and reduces rolling resistance.

In embodiments, the silica may comprise silicon compounds such as wet silica (hydrated silicic acid), dry silica (anhydrous silicic acid), calcium silicate, aluminum silicate, or a combination thereof.

In embodiments, the amount of silica in the rubber formulation may be greater than or equal to about 8 phr, greater than or equal to about 12 phr, greater than or equal to about 16 phr, or even greater than or equal to about 20 phr. In embodiments, the amount of silica in the rubber formulation may be less than or equal to about 40 phr, less than or equal to about 36 phr, less than or equal to about 32 phr, or even less than or equal to about 28 phr. In embodiments, the amount of silica in the rubber formulation may be from about 8 phr to about 40 phr, from about 8 phr to about 36 phr, from about 8 phr to about 32 phr, from about 8 phr to about 28 phr, from about 12 phr to about 40 phr, from about 12 phr to about 36 phr, from about 12 phr to about 32 phr, from about 12 phr to about 28 phr, from about 16 phr to about 40 phr, from about 16 phr to about 36 phr, from about 16 phr to about 32 phr, from about 16 phr to about 28 phr, from about 20 phr to about 40 phr, from about 20 phr to about 36 phr, from about 20 phr to about 32 phr, or even from about 20 phr to about 28 phr, or any and all sub-ranges formed from any of these endpoints.

In embodiments, the amount of silica in the rubber formulation may be greater than or equal to about 0 phr, greater than or equal to about 5 phr, greater than or equal to about 10 phr, greater than or equal to 15 phr, or even greater than or equal to about 20 phr. In embodiments, the amount of silica in the rubber formulation may be less than or equal to about 60 phr, less than or equal to about 50 phr, less than or equal to about 40 phr, less than or equal to 30 phr or even less than or equal to about 30 phr. In embodiments, the amount of silica in the rubber formulation may be from about 0 phr to about 60 phr, from about 0 phr to about 50 phr, from about 0 phr to about 40 phr, from about 0 phr to about 30 phr, from about 5 phr to about 60 phr, from about 5 phr to about 50 phr, from about 5 phr to about 40 phr, from about 5 phr to about 30 phr, from about 10 phr to about 60 phr, from about 10 phr to about 50 phr, from about 10 phr to about 40 phr, from about 10 phr to about 30 phr, from about 15 phr to about 60 phr, from about 15 phr to about 50 phr, from about 15 phr to about 40 phr, from about 15 phr to about 30 phr, from about 20 phr to about 60 phr, from about 20 phr to about 50 phr, from about 20 phr to about 40 phr, or even from about 20 phr to about 30 phr, or any and all sub-ranges formed from any of these endpoints.

In embodiments, the carbon black may comprise fast extrusion furnace black, semi-reinforcing furnace black, high abrasion furnace black, intermediate super abrasion furnace black, super abrasion furnace black, and the like. In embodiments, the carbon black may have an iodine absorption greater than or equal to about 60 mg/g or more and a dibutylphthalate oil absorption value greater than or equal to about 80 ml/100 g.

In embodiments, the amount of carbon black in the rubber formulation may be greater than or equal to about 4 phr, greater than or equal to about 8 phr, or even greater than or equal to about 12 phr. In embodiments, the amount of carbon black in the rubber formulation may be less than or equal to 32 phr, less than or equal to 28 phr, less than or equal to 24 phr, or even less than or equal to 20 phr. In embodiments, the amount of carbon black in the rubber formulation may be from about 4 phr to about 32 phr, from about 4 phr to about 28 phr, from about 4 phr to about 24 phr, from about 4 phr to about 20 phr, from about 8 phr to about 32 phr, from about 8 phr to about 28 phr, from about 8 phr to about 24 phr, from about 8 phr to about 20 phr, from about 12 phr to about 32 phr, from about 12 phr to about 28 phr, from about 12 phr to about 24 phr, or even from about 12 phr to about 20 phr, or any and all sub-ranges formed from any of these endpoints.

In embodiments, the amount of carbon black in the rubber formulation may be greater than or equal to about 0 phr, greater than or equal to about 4 phr, greater than or equal to about 8 phr, greater than or equal to 12 phr, greater than or equal to 16 phr, or even greater than or equal to about 20 phr. In embodiments, the amount of carbon black in the rubber formulation may be less than or equal to 70 phr, less than or equal to 60 phr, less than or equal to 50 phr, less than or equal to 46 phr, less than or equal to 42 phr, less than or equal to 38 phr, less than or equal to 34 phr, less than or equal to 30 phr, less than or equal to 26 phr, or even less than or equal to 22 phr. In embodiments, the amount of carbon black in the rubber formulation may be from about 0 phr to about 70 phr, from about 0 phr to about 60 phr, from about 0 phr to about 50 phr, from about 0 phr to about 46 phr, from about 0 phr to about 42 phr, from about 0 phr to about 38 phr, from about 0 phr to about 34 phr, from about 0 phr to about 30 phr, from about 0 phr to about 26 phr, from about 0 phr to about 22 phr, from about 4 phr to about 70 phr, from about 4 phr to about 60 phr, from about 4 phr to about 50 phr, from about 4 phr to about 46 phr, from about 4 phr to about 42 phr, from about 4 phr to about 38 phr, from about 4 phr to about 34 phr, from about 4 phr to about 30 phr, from about 4 phr to about 26 phr, from about 4 phr to about 22 phr, from about 8 phr to about 70 phr, from about 8 phr to about 60 phr, from about 8 phr to about 50 phr, from about 8 phr to about 46 phr, from about 8 phr to about 42 phr, from about 8 phr to about 38 phr, from about 8 phr to about 34 phr, from about 8 phr to about 30 phr, from about 8 phr to about 26 phr, from about 8 phr to about 22 phr, from about 12 phr to about 70 phr, from about 12 phr to about 60 phr, from about 12 phr to about 50 phr, from about 12 phr to about 46 phr, from about 12 phr to about 42 phr, from about 12 phr to about 38 phr, from about 12 phr to about 34 phr, from about 12 phr to about 30 phr, from about 12 phr to about 26 phr, or even from about 12 phr to about 22 phr, or any and all sub-ranges formed from any of these endpoints.

In embodiments, the reinforcing filler may comprise at least one of silica and carbon black. In some embodiments, the rubber formulation may include silica and be exclusive of carbon black. In other embodiments, the rubber formulation may include carbon black and be exclusive of silica. In certain embodiments, the rubber formulation may comprise both carbon black and silica such that a balance of the desired properties can be achieved. Carbon black is typically used for wear performance, but can show a deficit in rolling resistance. Silica is typically used for rolling resistance and sometimes tear, but can show a deficit in wear performance. Both filler types can be used simultaneously to balance the advantages and tradeoffs to achieve the desired performance for the rubber formulation.

In embodiments, the reinforcing filler may comprise about 30 wt % to about 70 wt % silica and about 30 wt % to 70 wt % carbon black, about 35 wt % to about 65 wt % silica and about 35 wt % to about 65 wt % carbon black, or even from about 40 wt % to about 60 wt % silica and about 40 wt % to about 60 wt % carbon black.

In embodiments, in addition to silica and carbon black, other filler may be included in the rubber formulation. The fillers that may be included are conventionally employed in the manufacture of tires, including starch, aluminum hydroxide, magnesium hydroxide, clays (hydrated aluminum silicates), and combinations thereof.

### Rubber Formulation

As described herein, the rubber formulations disclosed herein replace natural rubber with functionalized conjugated diene polymer. Miscibility is measured by a deviation of the transition temperature T_{g} on the rubber composition from a predicted T_{g} for the control composition. As indicated by a shift in the loss modulus G″ peak of the rubber formulation at the transition temperature T_{g} of the natural rubber as compared to a control rubber formulation, the functionalized conjugated diene polymer is preferentially miscible with natural rubber and favors a natural rubber phase over a high-cis butadiene rubber phase.

As indicated by a reduction in change in storage modulus ΔG′ as compared to a control rubber formulation as measured in strain sweep from 0.25% to 10% strain, run at 60° C. and 10 Hz, while being preferentially miscible with the natural rubber, the functionalized conjugated diene polymer may react with the silica or carbon black and improve silica or carbon black dispersion in the natural rubber phase. In embodiments, the rubber formulation may have a change in storage modulus ΔG′ less than or equal to 0.950 as measured in strain sweep from 0.25% to 10% strain, run at 60° C. and 10 Hz.

The rubber formulations disclosed herein have a decrease in the loss tangent tan δ at 60° C. as compared to a control rubber formulation, which correlates to reduced rolling resistance. In embodiments, the rubber formulation may have a tan δ at 60° C. less than or equal to 0.110.

Moreover, replacing natural rubber with functionalized conjugated diene polymer has minimal to no effect on tensile properties (e.g., modulus at 300% strain M300, stress at break Tb, and maximum strain Eb), wet traction as indicated by loss tangent tan δ at 0° C., and cornering coefficient as indicated by storage modulus E′ at 30° C. as compared to a control rubber formulation.

In embodiments, the rubber formulation may have a modulus at 300% strain M300 at room temperature from about 5.0 MPa to about 6.5 MPa. In embodiments, the rubber formulation may have a stress at break at room temperature from about 23.0 MPa to about 28.0 MPa. In embodiments, the rubber formulation may have a maximum strain at break from about 650% to about 725%. In embodiments, the rubber formulation may have a loss tangent tan δ at 0° C. from about 0.220 to about 0.240. In embodiments, the rubber formulation may have a storage modulus E′ at 30° C. from about 5.0 to about 6.0.

In embodiments, the rubber formulation may have a Mooney viscosity (ML(1+4)) similar to the control rubber formulation for ease of processability.

### Other Components

In embodiments, the rubber formulation may further comprise silane as a coupling agent.

In embodiments, the rubber formulation may further comprise sulfur as a vulcanizing agent. A vulcanization accelerator may be used along with a vulcanizing agent to control the time and/or temperature required for vulcanization and to improve properties of the vulcanizate. The vulcanization accelerators suitable for use in the disclosed compositions are not particularly limited. Examples of vulcanization accelerator include thiazol vulcanization accelerators, such as 2-mercaptobenzothiazol, dibenzothiazyl disulfide, N-cyclohexyl-2-benzothiazyl-sulfenamide, N-tert-butyl-2-benzothiazyl sulfenamide, and the like; guanidine vulcanization accelerators, such as diphenylguanidine and the like; amines; disulfides; thiurams; sulfenamides; dithiocarbamates; xanthates; and thioureas; among others.

In embodiments, useful processing or extender oils may also be included. In embodiments, oils may include those that are commercially available as paraffinic, aromatic, or naphthenic oils. In embodiments, the major constituent of the oil may be paraffinic. In embodiments, the extender oil may be oil extended sulfur.

The components may also include other additives such as anti-ozonants, waxes, scorch inhibiting agents, processing aids, zinc oxide, tackifying resins, reinforcing resins, fatty acids such as stearic acid, peptizers, and one or more accelerators.

The anti-ozonants may comprise N,N′-disubstituted-p-phenylenediamines, such as N-1,3-dimethylbutyl-N′-phenyl-p-phenylenediamine, N,N′-bis(1,4-dimethylpently)-p-phenylenediamine, N-phenyl-N-isopropyl-p-phenylenediamine, and N-phenyl-N′-(1,3-dimethylbutyl)-p-phenylenediamine. Other examples of anti-ozonants may include, acetone diphenylamine condensation product, 2,4-trimethyl-1,2-dihydroquinoline, octylated diphenylamine, and 2,6-di-t-butyl-4-methyl phenol.

In embodiments, the rubber formulation may further comprise a heat curable resin. Non-limiting examples of such resins include epoxies, urethanes and phenol-formaldehydes, and combinations of one or more of the foregoing may also be utilized. In embodiments, the rubber formulation may comprise at least one of the following types of resins: (1) phenolic resins such as phenol novolak resins, phenol-formaldehyde resins, resorcinol-formaldehyde resins, reactive resol resins (which can react with unsaturation in an elastomer or rubber to contribute to crosslinking), and reactive novolak type phenol-formaldehyde resins (which can crosslink with methylene donors); (2) aliphatic resins such as C₅ fraction homopolymer or copolymer resins, optionally in combination with one or more of e.g., cycloaliphatic, aromatic, hydrogenated aromatic, or terpene resins and/or optionally partially or fully hydrogenated; (3) cycloaliphatic resins (such as cyclopentadiene homopolymer or copolymer resins, and dicyclopentadiene homopolymer or copolymer resins), optionally in combination with one or more of aliphatic, aromatic, hydrogenated aromatic, or terpene resins, and/or optionally partially or fully hydrogenated; (4) aromatic resins (such as coumarone-indene resins and alkyl-phenol resins as well as vinyl aromatic homopolymer or copolymer resins such as those including one or more of the following monomers: alpha-methylstyrene, styrene, ortho-methylstyrene, meta-methylstyrene, para-methylstyrene, vinyltoluene, para(tert-butyl)styrene, methoxystyrene, chlorostyrene, hydroxystyrene, vinylmesitylene, divinylbenzene, vinylnaphthalene or any vinyl aromatic monomer resulting from C₉ fraction or C₅-C₁₀ fraction), optionally in combination with one or more of aliphatic, cycloaliphatic, hydrogenated aromatic, or terpene resins, and/or optionally partially or fully hydrogenated; (5) terpene resins (such as alpha-pinene resins, beta-pinene resins, limonene resins (e.g., L-limonene, D-limonene, dipentene which is a racemic mixture of L- and D-isomers), beta-phellandrene, delta-3-carene, and delta-2-carene), optionally in combination with one or more of aliphatic, cycloaliphatic, aromatic, or hydrogenated aromatic resins, and/or optionally partially or fully hydrogenated, and tall oil rosin, glycerin ester rosins, and pentaerythritol ester rosins (optionally partially hydrogenated and/or polymerized), (6) rosin resins (such as gum rosin, wood rosin, and tall oil rosin, glycerin ester rosins, and pentaerythritol ester rosins (optionally partially hydrogenated and/or polymerized)), optionally in combination with one or more of aliphatic, cycloaliphatic, aromatic, hydrogenated aromatic, or terpene resins, and/or optionally partially or fully hydrogenated; or (7) guayule resins. A mixture of one or more resins also can be used.

### Method of Making

In embodiments, to form a conjugated diene polymer (e.g., polybutadiene), a monomer (e.g., 1,3 butadiene monomer) may be polymerized using an organic lithium initiator. In embodiments, the organic lithium initiator may be alkyl lithium (e.g., n-butyl lithium, sec-butyl lithium, ethyl lithium, propyl lithium, t-butyl lithium and hexyl lithium), alkylene dilithium (e.g., 1,4-dilithiobutane), lithiohydrocarbon (e.g., phenyl lithium, stilbene dilithium and reaction products of butyl lithium and divinyl benzene), or organic lithiometals (e.g., lithium tributyltin), lithium amides (e.g., lithium diethylamide, N-methylbenzyl lithium amide, dioctyllithium amide, lithium piperidide, lithium pyrrolidide and lithium hexamethylene imide), or organic lithium (e.g., tertiary amine lithiums such as dimethylaminopropyl lithium and diethylaminopropyl lithium).

In embodiments, the conjugated diene polymer may be functionalized by reacting an active terminal of the polymer with a functional group (e.g., 3-(1,3-dimethylbutylidene)aminopropylmethyldiethoxysilane). After functionalization is complete, neutralization of any remaining reactive species (e.g., lithium species) may be accomplished by treatment with a protic source, such as water or isopropyl alcohol containing 2,5-di-tert-butyl-4-methylphenol.

A 1,2-microstructure controlling agent or randomizing modifier is optionally used to control the 1,2-microstructure in the conjugated diene contributed monomer units, such as 1,3-butadiene. Suitable modifiers include hexamethylphosphoric acid triamide, N,N,N′,N-tetramethylethylene diamine, ethylene glycol dimethyl ether, diethylene glycol dimethyl ether, triethylene glycol dimethyl ether, tetraethylene glycol dimethyl ether, tetrahydrofuran, 1,4-diazabicyclo [2.2.2]octane, diethyl ether, triethylamine, tri-n-butylamine, tri-n-butylphosphine, p-dioxane, 1,2-dimethoxy ethane, dimethyl ether, methyl ethyl ether, ethyl propyl ether, di-n-propyl ether, di-n-octyl ether, anisole, dibenzyl ether, diphenyl ether, dimethylethylamine, bis-oxalanyl propane, tri-n-propyl amine, trimethyl amine, triethyl amine, N,N-dimethyl aniline, N-ethylpiperidine, N-methyl-N-ethyl aniline, N-methylmorpholine, tetramethylenediamine, oligomeric oxolanyl propanes, 2,2-bis-(4-methyl dioxane), bistetrahydrofuryl propane, and 2,2-di(2-tetrahydrofuryl)propane. A mixture of one or more randomizing modifiers also may be used.

In embodiments, the functionalized conjugated diene polymer may be included in a rubber formulation by forming a masterbatch with the functionalized conjugated diene rubber, natural rubber, silica and/or carbon black, and other components and mixing. In embodiments, the masterbatch mixing stage may be followed by a remill stage to incorporate additional components.

While the above describes the use of the rubber compositions in tire treads, the rubber compositions of the present disclosure may be utilized in various other components or articles, which utilize such rubber compositions. Typical articles may include, but are not limited to, tire sidewalls, inner-tubes and tire inner liners, air cushions, pneumatic sprays, air bags, tire-curing bladders, high temperature hoses and conveyor belts, damping mounts for engines and the like.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

What is claimed is:

1. A rubber formulation comprising:
functionalized conjugated diene polymer having a functional group, a vinyl content greater than or equal to about 50%, and a weight average molecular weight M_{w} of about 75,000 g/mol to about 1,000,000 g/mol;
natural rubber; and
reinforcing filler comprising at least one of silica and carbon black.

2. The rubber formulation of claim 1, wherein the functionalized conjugated diene polymer has a weight average molecular weight M_{w} of about 100,000 g/mol to about 800,000 g/mol, or about 200,000 g/mol to about 600,000 g/mol, or about 300,000 g/mol to about 400,000 g/mol.

3. The rubber formulation of claim 1, wherein the functional group comprises a non-sulfur alkoxysilane group.

4. The rubber formulation of claim 3, wherein the non-sulfur alkoxysilane group has at least two alkoxysilane terminal moieties.

5. The rubber formulation of claim 3, wherein the non-sulfur alkoxysilane group comprises 3-(1,3-dimethylbutylideneaminopropylmethyldiethoxysilane; 3-(1,3-dimethylbutylidene)aminopropyltriethoxysilane; N,N-bis(trimethylsilyl)-aminopropylmethyldimethoxysilane; N,N-bis(trimethylsilyl)-aminopropylmethyldiethoxysilane; γ-glycidoxypropylmethyldiethoxysilane; or a combination thereof.

6. The rubber formulation of claim 3, wherein the functional group has the general formula:
R¹ZYSi(OR²)ₙX₍₃₋ₙ₎,
wherein R¹ is a substituent selected from a C₁-C₂₀ aliphatic hydrocarbon group, a C₁-C₂₀ alicyclic hydrocarbon group, C₁-C₂₀ aromatic hydrocarbon group, or a C₁-C₂₀ heterohydrocarbon group having one or more heteroatoms selected from O, N, and Si, X is an alkyl group or halogen atom, and R² and Y independently denote a group selected from aliphatic, alicyclic, and aromatic hydrocarbon groups of 1 to 20 carbon atoms.

7. The rubber formulation of claim 1, wherein the functional group comprises a tin-based group, an amine group, or a combination thereof.

8. The rubber formulation of claim 7, wherein the tin-based group comprises tin tetra halide, (R₁)₃SnX, (R₁)₂SnX₂, R₁SnX₃, or a combination thereof, where X is Cl, Br, I, or F, and R₁ is an alkyl, cycloalkyl, or aralkyl having from 1 to about 20 carbon atoms.

9. The rubber formulation of claim 7, wherein the amine group comprises at least one of an amine radical having the general formula: 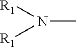
and a cyclic amine radical having the general formula: 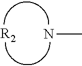
where R₁ is an alkyl, cycloalkyl, or aralkyl having from 1 to about 12 carbon atoms, and R₂ is an alkylene, substituted alkylene, oxy- or N-alkylamino-alkylene group having from about 3 to about 16 methylene groups.

10. The rubber formulation of claim 1, wherein the functionalized conjugated diene polymer has a vinyl content of about 50% to about 90%, or about 55% to about 85%, or about 60% to about 80%.

11. (canceled)

12. The rubber formulation of claim 1, wherein the rubber formulation comprises about 3 phr to about 50 phr of the functionalized conjugated diene polymer.

13. (canceled)

14. The rubber formulation of claim 1, wherein the reinforcing filler comprises greater than about 0 phr to about 85 phr silica.

15. (canceled)

16. The rubber formulation of claim 1, wherein the reinforcing filler comprises about 4 phr to about 70 phr carbon black.

17. The rubber formulation of claim 1, wherein the reinforcing filler comprises about 30 wt % to about 70 wt % silica and about 30 wt % to 70 wt % carbon black

18. A rubber formulation of claim 1, wherein the functionalized conjugated diene polymer comprises a polymerized reaction product of 1,3-butadiene monomer.

19. The rubber formulation of claim 1, wherein the functionalized conjugated diene polymer comprises polybutadiene rubber.

20. The rubber formulation of claim 1, wherein the rubber formulation further comprises from about 15 phr to 45 phr of high-cis 1,4-polybutadiene.

21. The rubber formulation of claim 1, wherein the rubber formulation further comprises about 10 phr to about 100 phr natural rubber.

22. The rubber formulation of claim 1, wherein the rubber formulation further comprises greater than about 0 phr to about 85 phr natural rubber.

23. (canceled)

24. The rubber formulation of claim 21, wherein the natural rubber comprises guayule rubber.
